(19) United States
(12) Patent Application Publication
(10) Pub. No.: US 2026/0321250 A1
(43) Pub. Date: Oct. 15, 2026

(54) DEEP LEARNING BASED MITIGATION OF AUDIO ARTIFACTS

(71) Applicant: DOLBY LABORATORIES LICENSING CORPORATION

(72) Inventors: Jia Dai, Beijing (CN); Kai Li, Beijing (CN); Xiaoyu Liu, Dublin, CA (US)

(73) Assignee: DOLBY LABORATORIES LICENSING CORPORATION, (US)

(21) Appl. No.: 19/101,160

(22) PCT Filed: Jul. 28, 2023
(86) PCT No.: PCT/US23/28943

§ 371 Date: Feb. 4, 2025

Related U.S. Application Data
(60) Provisional application No. 63/424,620, filed on Nov. 11, 2022.

(30) Foreign Application Priority Data
Aug. 5, 2022 (WO) PCT/CN2022/110612
Dec. 20, 2022 (EP) 22214817.3

(51) Int. Cl. G10L 15/16; G06N 3/0464

(52) U.S. Cl. CPC G10L 15/16; G06N 3/0464

(57) ABSTRACT

A system is programmed to build a machine learning model that comprises a series of masking blocks. Each masking block receives a certain feature vector of an audio segment. Each masking block comprises a first component that generates a first mask for extracting clean speech and a second component that generates a second mask for extracting residual speech masked by the first mask. Each masking block also generates a specific feature vector based on the first mask and the second mask, which becomes the certain feature vector for the next masking block. The second component, which may comprise a gated recurrent unit layer, is computationally less complex than the first component, which may comprise multiple convolutional layers. Furthermore, the system is programmed to receive an input feature vector of an input audio segment and execute the machine learning model to obtain an output feature vector of an output audio segment.

### CROSS REFERENCE TO RELATED APPLICATIONS

This application claims priority to PCT Application No. PCT/CN2022/110612, filed Aug. 5, 2022; U.S. Provisional Application No. 63/424,620, filed on Nov. 11, 2022; and European Patent Application No. 22214817.3, filed on Dec. 20, 2022, each of which is incorporated by reference in its entirety.

### TECHNICAL FIELD

The present application relates to audio processing and machine learning.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In recent years, various machine learning models have been adopted for speech enhancement. Compared to traditional signal-processing methods, such as Wiener Filter or Spectral Subtraction, the machine learning methods have demonstrated significant improvements, especially for non-stationary noise and low signal-to-noise ratio (SNR) conditions.

Existing machine learning methods for speech detection and enhancement often suffer from speech over-suppression, which can lead to speech distortion or even discontinuity. In addition, existing machine learning methods for speech detection and enhancement are typically developed to each mitigate one type of artifacts, such as noise, reverberation echo, codec effects, packet loss, or howl effect.

It would be helpful to improve traditional machine learning methods for speech enhancement, specifically to efficiently reduce speech over-suppression and mitigating multiple types of artifacts, in stored audio content or real-time communication.

### SUMMARY

A computer-implemented method of mitigating audio artifacts is disclosed. The method comprises receiving, by a processor, audio data as a joint time-frequency representation over a plurality of frames and a plurality of frequency bands. The method further comprises executing, by the processor, a digital model for detecting speech from a feature vector of the audio data, the digital model comprising a series of masking blocks, each masking block comprising a first component that generates a first mask for extracting speech and a second component that generates a second mask for extracting residual speech masked by the first mask, and each mask of the first mask and the second mask including mask values estimating an amount of speech present for each frame of the plurality of frames and each frequency band of the plurality of frequency bands. In addition, the method comprises transmitting information related the first masks produced by the series of masking blocks to a device.

Techniques described in this specification are advantageous over conventional audio processing techniques. The method improves audio quality by mitigating various types of artifacts and sharpening speech without over-suppressing speech. The method utilizes a deep learning model configured to identify clean speech with low latency and reduce speech over-suppression with low complexity. The improved audio quality leads to better perception of the audio and better user enjoyment of the audio.

### BRIEF DESCRIPTION OF THE DRAWINGS

The example embodiment(s) of the present invention are illustrated by way of example, and not in way by limitation, in the figures of the accompanying drawings and in which like reference numerals refer to similar elements and in which:

FIG. 1 illustrates an example networked computer system in which various embodiments may be practiced.

FIG. 2 illustrates example components of an audio management computer system in accordance with the disclosed embodiments.

FIG. 3 illustrates a CGRU block comprising convolutional neural network (CNN) blocks and a gated recurrent unit (GRU) block.

FIG. 4 illustrates a deep neural network (DNN) comprising an input CNN block, CGRU blocks, and a mask combination block.

FIG. 5 illustrates an example process performed by an audio management computer system in accordance with some embodiments described herein.

FIG. 6 is a block diagram that illustrates a computer system upon which an embodiment of the invention may be implemented.

### DESCRIPTION OF THE EXAMPLE EMBODIMENTS

In the following description, for the purposes of explanation, numerous specific details are set forth in order to provide a thorough understanding of the example embodiment(s) the present invention. It will be apparent, however, that the example embodiment(s) may be practiced without these specific details. In other instances, well-known structures and devices are shown in block diagram form in order to avoid unnecessarily obscuring the example embodiment(s).

Embodiments are described in sections below according to the following outline:
1. GENERAL OVERVIEW
2. EXAMPLE COMPUTING ENVIRONMENTS
3. EXAMPLE COMPUTER COMPONENTS
4. FUNCTIONAL DESCRIPTIONS
   4.1. MODEL TRAINING FOR SPEECH ENHANCEMENT
      4.1.1. FEATURE EXTRACTION
      4.1.2. MACHINE LEARNING MODEL
      4.1.3. PERCEPTUAL LOSS FUNCTION
   4.2. MODEL EXECUTION FOR SPEECH ENHANCEMENT
5. EXAMPLE PROCESSES
6. HARDWARE IMPLEMENTATION
7. EXTENSIONS AND ALTERNATIVES

### 1. GENERAL OVERVIEW

A system for mitigating audio artifacts is disclosed. In some embodiments, a system is programmed to build a machine learning model that comprises a series of masking blocks. Each masking block receives a certain feature vector of an audio segment. Each masking block comprises a first component that generates a first mask for extracting clean speech and a second component that generates a second mask for extracting residual speech masked by the first mask. Each masking block also generates a specific feature vector based on the first mask and the second mask, which becomes the certain feature vector for the next masking block. The second component, which may comprise a GRU layer, is computationally less complex than the first component, which may comprise multiple CNN layers. Furthermore, the system is programmed to receive an input feature vector of an input audio segment and execute the machine learning model to obtain an output feature vector of an output audio segment that contains cleaner speech than the input audio segment.

In some embodiment, the first component comprises a first series of CNN blocks. The first series of CNN blocks includes CNN blocks having increasing dilation rates followed by decreasing dilation rates in the structure of an autoencoder plus a trailing CNN block for classification. Each CNN block can comprise a CNN layer with one or more filters followed by a batch normalization (BatchNorm) layer and an activation layer. The second component comprises a GRU block, which can comprise a GRU layer similarly followed by a BatchNorm layer and an activation layer. The masking component can also comprise a third component that comprises a second series of CNN blocks to combine the first mask and the second mask.

In some embodiments, the machine learning model comprises an input CNN block comprising a CNN layer with one or more lookahead filters, to enhance the input feature vector. The machine learning model can also comprise a mask combination block that is similar to the third component of a masking block. The mask combination block comprises a third series of CNN blocks to combine the first masks generated by the first series of CNN blocks of the series of masking blocks.

The system produces technical benefits. The system addresses the technical problem of improving audio data to enhance speech. The system improves audio quality by mitigating various types of artifacts and sharpening speech without over-suppressing speech. The system utilizes a deep learning model that identifies clean speech with low latency and reduce speech over-suppression with low complexity. The improved audio quality leads to better perception of the audio and better user enjoyment of the audio.

### 2. EXAMPLE COMPUTING ENVIRONMENTS

FIG. 1 illustrates an example networked computer system in which various embodiments may be practiced. FIG. 1 is shown in simplified, schematic format for purposes of illustrating a clear example and other embodiments may include more, fewer, or different elements.

In some embodiments, the networked computer system comprises an audio management server computer 102 (“server”), one or more sensors 104 or input devices, and one or more output devices 110, which are communicatively coupled through direct physical connections or via one or more networks 118.

In some embodiments, the server 102 broadly represents one or more computers, virtual computing instances, and/or instances of an application that is programmed or configured with data structures and/or database records that are arranged to host or execute functions related to audio enhancement. The server 102 can comprise a server farm, a cloud computing platform, a parallel computer, or any other computing facility with sufficient computing power in data processing, data storage, and network communication for the above-described functions.

In some embodiments, each of the one or more sensors 104 can include a microphone or another digital recording device that converts sounds into electric signals. Each sensor is configured to transmit detected audio data to the server 102. Each sensor may include a processor or may be integrated into a typical client device, such as a desktop computer, laptop computer, tablet computer, smartphone, or wearable device.

In some embodiments, each of the one or more output devices 110 can include a speaker or another digital playing device that converts electrical signals back to sounds. Each output device is programmed to play audio data received from the server 102. Similar to a sensor, an output device may include a processor or may be integrated into a typical client device, such as a desktop computer, laptop computer, tablet computer, smartphone, or wearable device.

The one or more networks 118 may be implemented by any medium or mechanism that provides for the exchange of data between the various elements of FIG. 1. Examples of the networks 118 include, without limitation, one or more of a cellular network, communicatively coupled with a data connection to the computing devices over a cellular antenna, a near-field communication (NFC) network, a Local Area Network (LAN), a Wide Area Network (WAN), the Internet, a terrestrial or satellite link, etc.

In some embodiments, the server 102 is programmed to receive input audio data corresponding to sounds in a given environment from the one or more sensors 104. The input audio data may comprise a plurality of frames over time. The server 102 is programmed to next process the input audio data, which typically corresponds to a mixture of speech and noise or other artifacts, to estimate how much speech is present (or detect the amount of speech) in each frame of the input audio data. The server can be programmed to send the final detection results to another device for downstream processing. The server can also be programmed to update the input audio data based on the final detection results to produce cleaned-up output audio data expected to contain cleaner speech than the input audio data, and send the output audio data to the one or more output devices 110.

### 3. EXAMPLE COMPUTER COMPONENTS

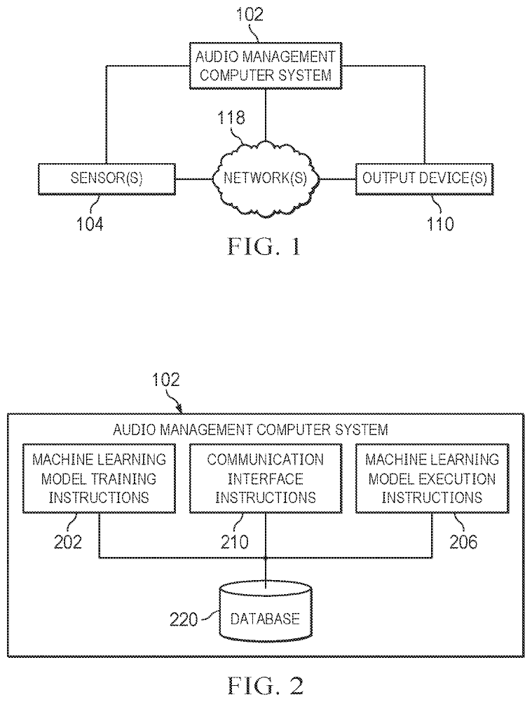

FIG. 2 illustrates example components of an audio management computer system in accordance with the disclosed embodiments. The figure is for illustration purposes only and the server 102 can comprise fewer or more functional or storage components. Each of the functional components can be implemented as software components, general or specific-purpose hardware components, firmware components, or any combination thereof. Each of the functional components can also be coupled with one or more storage components. A storage component can be implemented using any of relational databases, object databases, flat file systems, or Javascript Object Notation (JSON) stores. A storage component can be connected to the functional components locally or through the networks using programmatic calls, remote procedure call (RPC) facilities or a messaging bus. A component may or may not be self-contained. Depending upon implementation-specific or other considerations, the components may be centralized or distributed functionally or physically.

In some embodiments, the server 102 comprises machine learning model training instructions 202, machine learning model execution instructions 206, and communication interface instructions 210. The server 102 also comprises a database 220.

In some embodiments, the machine learning model training instructions 202 enable training machine learning models for detection of speech and mitigation of artifacts. The machine learning models can include various artificial neural networks (ANNs) or other transformation or classification models. The training can include extracting features from training audio data, feeding given or extracted features optionally with expected model output to a training framework to train a machine learning model, and storing the trained machine learning model. The output of the machine learning models could include an estimate of the amount of speech present in each given audio segment or an enhanced version of each given audio segment. The training framework can include an objective function designed to mitigate speech over-suppression.

In some embodiments, the machine learning model execution instructions 206 enable executing machine learning models for detection of speech and mitigation of artifacts. The execution can include extracting features from a new audio segment, feeding the extracted features to a trained machine learning model, and obtaining new output from executing the trained machine learning model. The new output can include an estimate of an amount of speech in the new audio segment or an enhanced version of the new audio segment.

In some embodiments, the communication interface instructions 210 enable communication with other systems or devices through computer networks. The communication can include receiving audio data or trained machine learning models from audio sources or other systems. The communication can also include transmitting speech detection or enhancement results to other processing devices or output devices.

In some embodiments, the database 220 is programmed or configured to manage storage of and access to relevant data, such as received audio data, digital models, features extracted from received audio data, or results of executing the digital models.

### 4. FUNCTIONAL DESCRIPTIONS

### 4.1. Model Training for Speech Enhancement

### 4.1.1. Data Collection

Speech signals are generally distorted by various contaminations or artifacts caused by the environment or the recording apparatus, such as noise or reverberation. In some embodiments, the server 102 is programmed to build a training dataset of audio segments that are distorted to various extents. The audio segments in the training dataset can include additive artifacts affecting different durations or frequency bands. An example approach of blending such artifacts with clean speech signals can be found in the paper on the improved version of a problem-agnostic speech encoder (PASE+) titled “Multi-task self-supervised learning for Robust Speech Recognition” by Ravanelli et al.

### 4.1.2. Feature Extraction

The training dataset of audio segments are typically represented in the time domain. In some embodiments, the server 102 is programmed to convert each audio segment comprising a waveform over a plurality of frames into a joint time-frequency (T-F) representation using a spectral transform, such as the short-term Fourier Transform (STFT), shifted modified discrete Fourier Transform (MDFT), or complex quadratic mirror filter (CQMF). The joined T-F representation covers a plurality of frames and a plurality of frequency bins.

In some embodiments, the server 102 is programmed to convert the T-F representation into a vector of banded energies, for 56 perceptually motivated bands, for example. Each perceptually motivated band is typically located in a frequency domain that matches how a human ear processes speech, such as from 120 Hz to 2,000 Hz, so that capturing data in these perceptually motivated band means not losing speech quality to a human ear. More specifically, the squared magnitudes of the output frequency bins of the spectral transform are grouped into perceptually motivated bands, where the number of frequency bins per band increases at higher frequencies. The grouping strategy may be “soft” with some spectral energy being leaked across neighboring bands or “hard” with no leakage across bands. Specifically, when the bin energies of a noisy frame are represented by x being a column vector of size p by 1, where p denotes the number of bins, the conversion to a vector of banded energies could be performed by computing y=W*x, where y is a column vector of size q by 1 representing the band energies for this noisy frame, W is a banding matrix of size q by p, and q denotes the number of perceptually motivated bands.

In some embodiments, the server 102 is then programmed to compute the logarithm of each banded energy as a feature value for each frame and each frequency band. Alternatively, the band energy can be used directly as a feature value. For each joint T-F representation, an input feature vector comprising feature values can thus be obtained for the plurality of frames and the plurality of frequency bands.

In some embodiments, for supervised learning, the server 102 is programmed to retrieve or compute, for each joint T-F representation, an expected mask indicating an amount of speech present for each frame and each frequency band. The mask can be in the form of the logarithm of the ratio of the speech energy and the sum of all energies. The server 102 can include the expected masks in the training dataset.

### 4.1.2. Machine Learning Model

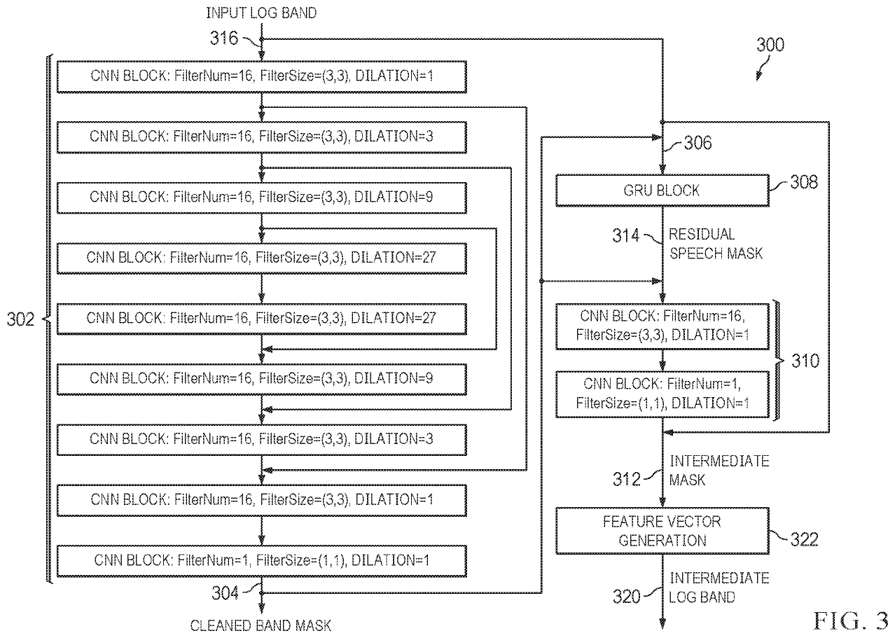

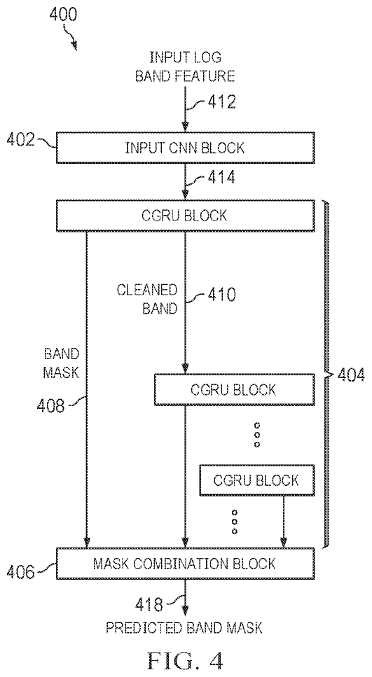

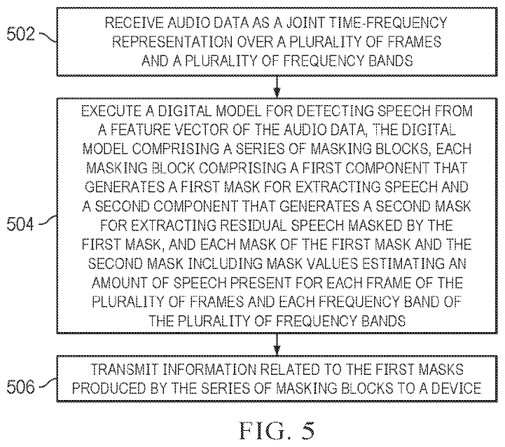

In some embodiments, the server 102 is then programmed to train a machine learning model using the training dataset. FIG. 3 illustrates a CGRU block comprising CNN blocks and a GRU block. All aspects of FIGS. 3 and 4, including the number of blocks, type of blocks, or the values of parameters, are shown for illustration purposes only. The CGRU block 300 receives an input feature vector 316 of an input audio segment and produces an output mask 312 and an output feature vector 320 corresponding to cleaner speech. The input feature vector 316 can be in the form of (N, C, F, T), where N denotes the batch size (e.g., number of audio files), C denotes the number of channels, F denotes a value in the frequency dimension, and T denotes a value in the time dimension. The CGRU block 300 contains a first series of CNN blocks 302 and a GRU block 308 that generate respective masks 304 and 314 for separating additive artifacts from clean speech in the input audio segment while reducing speech over-suppression. Each of the masks 304 and 314 can also be in the form of (N, C, F, T). The CGRU block 300 also contains a second series of CNN blocks 310 that combines the masks 304 and 314 into an output mask 312 that can be applied to the input feature vector 316 for further speech enhancement, as further discussed below. The CGRU block 300 serves as one component of a deep neural network (DNN), as further discussed below.

In some embodiments, the first series of CNN blocks 302 is intended for detecting clean speech. The first series of CNN blocks 302 contains a first sub-series of dilated CNN blocks with increasing dilation rates (e.g., 1, 3, 9, 27 along the time dimension), followed by a second sub-series of dilated CNN blocks with corresponding decreasing dilation rates (e.g., 27, 9, 3, 1 along the time dimension), followed by one trailing CNN block. As illustrated, the first series of CNN blocks 302 receives an input feature vector 316. Each CNN block in the first series receives a certain feature vector of an audio segment and produce a specific feature vector of an enhanced audio segment. The output of each CNN block in the first series becomes the input of the next CNN block in the first series. The output of each CNN block in the first sub-series is joined with the input of the CNN block with the same dilation rate in second sub-series. The join can be performed with adding or concatenation. The dilated CNN blocks each use a number of relatively small filters, such as 16 3×3 filters, while the trailing CNN block uses one 1×1 filter. In other embodiments, the length of the first sub-series or second sub-series, the dilation rates, the number of filters, and the size of each filter can vary.

Therefore, the first sub-series of CNN blocks with growing receptive fields performs encoding of feature data (to find more, better features) characterizing clean speech in original audio data, and the second sub-series of CNN blocks performs reconstruction of enhanced audio data. The trailing CNN block performs a linear projection of the feature maps into a summary feature map that can indicate how much speech is present in the original audio data. The first series of CNN blocks thus projects discriminative features at different levels onto a high-resolution space, namely at the per-band level at each frame, to get a dense classification (how much speech is present for each time frame and for each frequency band), namely the first mask 304.

In some embodiments, the GRU block 308 is intended for detecting any speech that might have been over-suppressed by the first series of CNN blocks 302. The input feature vector 316 and the first mask 304 produced by the first series of CNN blocks can be combined (the combination not shown as a separate block in FIG. 3) to generate a residual feature vector 306 that corresponds to the portion of the input feature vector 316 that is not identified as speech by the first mask 304. For example, the inverse I(m) of each value m of the first mask 304, such as log(1−e^{m}), can be applied to the corresponding feature value f of the input feature vector, such as I(m)+f, to generate an inverse of the result of applying the first mask 304 to the input feature vector 316 as a value of the residual feature vector 306.

In some embodiments, the GRU block 308 then receives the residual feature vector 306 and generates a residual mask 314. The GRU block 308 can comprise one or more GRU layers followed by a BatchNorm layer followed by an activation layer, as these layers are known to someone of ordinary skill in the art. The BatchNorm layer can accept one-dimensional inputs (BatchNorm1d). Each GRU layer can comprise a certain number of nodes that is equal to the number of features in each feature vector. The GRU layer provides a gating mechanism in a recurrent neural network (RNN) often used for processing time series data. Its relatively simple structure can lead to relatively loose filtering of non-speech and thus can be especially appropriate for detecting a relatively small amount of residual speech. The relatively simple structure also helps achieve low complexity for the machine learning model. In other embodiments, to further reduce the complexity, the GRU layer can be replaced by a simple fully connected layer without any recurrent connection. Even further simplification is possible by using one-dimensional filters along the time dimension instead of two-dimensional filters in the layer. The BatchNorm layer typically helps finetune the output of the previous layer and avoid internal covariate shift. The activation layer typically helps keeping an output value restricted to a certain limit and add non-linearity to the ANN. In certain embodiments, the BatchNorm layer can be placed before the activation layer.

In some embodiments, the second series of CNN blocks 310 is intended for generating an output mask 312 that leads to cleaner speech than the input audio segment. The second series of CNN blocks 310 can contain two CNN blocks, the first CNN block having a number of relatively small filters, such as 16 3×3 filters, and the second CNN block is similar to the trailing CNN block in the first series of CNN blocks. The second series of CNN blocks 310 receives the first mask 304 and the residual mask 314, joins the two masks (e.g., concatenation), and generates the output mask 312. In other embodiments, the length of the second series, the number of filters, and the size of each filter can vary.

Therefore, the first CNN block of the second series of CNN blocks 310 identifies specific patterns from the masks 304 and 314 and the second CNN block of the second series of CNN blocks 310 again performs classification, to determine an effective way of combining the first mask 304 and the residual mask 314. The output mask 312 is then applied to the input feature vector 316 via the feature vector generation 322 to produce an output feature vector 320 similar to the inverse of the first mask 304 being applied to the input feature vector 316 to produce the residual feature vector 306, as described above.

In some embodiments, each CNN block in the CGRU block 300 contains a CNN layer, a BatchNorm layer, and an activation layer. The CNN layer comprises two-dimensional filters for causal convolution. The BatchNorm layer accepts two-dimensional inputs (BatchNorm2d). The activation layer can be similar to that in the GRU block.

FIG. 4 illustrates a deep neural network comprising an input CNN block, CGRU blocks, and a mask combination block. The DNN 400 includes an input CNN block 402, a series of CGRU blocks 404 each corresponding to 300 illustrated in FIG. 3, and a mask combination block 406. The DNN 400 receives an original feature vector 412 of an original audio segment and predicts a final mask 418 to be used to extract clean speech from the original audio segment.

In some embodiments, the input CNN block 402 is intended for enriching the original feature vector 412. The input CNN block 402 contains a CNN layer, a BatchNorm layer and an activation layer. In the CNN layer, compared to the CNN layer in each CNN block in a CGRU block, each filter is applied to a small number of future frames, such as an additional lookahead of two frames. Such a filter can be referred to as a lookahead filter. Therefore, the input CNN block 402 receives the original feature vector 412 and produces a feature map as an improved feature vector 414. The relatively small amount of additional lookahead helps achieve low latency of the DNN 400 while producing enriched features. In other embodiments, this input CNN block 402 is absent, and the original feature vector 412 is directly received by the series of CGRU blocks 404.

In some embodiments, the first CGRU block of the series of CGRU blocks 404 receives the improved feature vector 414 and predicts a mask 408 that corresponds to 308 in FIG. 3 and generates a feature vector 410 that corresponds to 320 in FIG. 3. The feature vector 410 then becomes an input to the next CGRU block, and the process continues through the series of CGRU blocks 404. As noted above, the first series of CNN blocks of each CGRU block is intended for eliminating as much non-speech as possible, although it may also eliminate some speech. The GRU block of each CGRU block is intended for bringing back eliminated speech, although it may also bring back some non-speech. The iterative composition of the CGRU blocks in the series of CGRU blocks 404 is intended for ultimately retaining as much clean speech as possible while eliminating as much non-speech as possible, including various artifacts, such as echo, noise, or reverb. Experiments show that a near equilibrium point may be reached as a result of four CGRU blocks, for example. In other embodiments, the length of the series of CGRU blocks can vary.

The mask combination block 406 is intended for effectively combining the masks predicted by the series of CGRU blocks 404. The mask combination block 406 receives the first mask predicted by the first series of CNN blocks in each CGRU block of the series of CGRU blocks 404 and produces the final mask 418. The mask combination block 406 contains two CNN blocks, which are similar to the second series of CNN blocks 310 in FIG. 3. The first CNN block identifies specific patterns from the first masks and the second CNN blocks again performs classification, to determine an effective way of combining the first masks. While the second series of CNN blocks 310 takes two masks and produces an output mask 312, the mask combination block 406 takes four (or the number of CGRU blocks) masks and produces a final mask 418.

### 4.1.3. Perceptual Loss Function

In some embodiments, the server 102 is programmed to train the machine learning model using an appropriate optimization method known to someone skilled in the art. The optimization method, which is often iterative in nature, can minimize a loss (or cost) function that measures an error of the current estimate from the ground truth. For an ANN, the optimization method can be stochastic gradient descent, where the weights are updated using the backpropagation of error algorithm.

Traditionally, the objective function or loss function, such as the mean squared error (MSE), does not reflect human auditory perception well. A processed speech segment with a small MSE does not necessarily have high speech quality and intelligibility. Specifically, the objective function does not differentiate negative detection errors (false negatives, speech over-suppression) from positive detection errors (false positives, speech under-suppression), even if speech over-suppression may have a greater perceptual effect than speech under-suppression and is often treated differently from speech under-suppression in speech enhancement applications.

Speech over-suppression can hurt speech quality or intelligibility more than speech under-suppression. Speech over-suppression occurs when a predicted (estimated) mask value is less than the ground-truth mask value, as less speech is being predicted than the ground truth and thus more speech is being suppressed than necessary.

In some embodiments, a perceptual cost function that discourages speech over-suppression is used in the optimization method to train the machine learning model. The perceptual cost function is non-linear with asymmetric penalty for speech over-suppression and speech under-suppression. Specifically, the cost function assigns more penalty to a negative difference between the predicted mask value and the ground-truth mask value and less penalty to a positive difference. Experiments show that the perceptual loss function performs better than the MSE, for example, in reducing over-suppression on high-frequency fricative voices and low-level filled pauses, such as “um” and “uh”.

In some embodiments, the perceptual loss function Loss is defined as follows:

$$diff = {y}_{target}^{p} - {y}_{pred i cted}^{p} \qquad ( 1 )$$

$$Loss = {m}^{diff} - diff - 1 , \qquad ( 2 )$$

where y_{target} is the target (ground truth) mask value for a frame and a frequency band, y_{predicted} is the predicted mask value for the frame and the frequency band, m is a tuning parameter that can control the shape of the asymmetric penalty, and p is the power-law term or the scaling exponent. For example, m can be 2.6, 2.65, 2.7, etc. and p can be 0.5, 0.6, 0.7, etc. As y_{predicted} or y_{target} is less than one, such fractional values that are not overly small (e.g., that are greater than 0.5) for p tend to amplify smaller values for y_{predicted} more than larger values for y_{predicted} Or y_{target}. Such fractional values for p tend to further render the difference between y_{target}^{p} and y_{predicted}^{p} larger than the difference between y_{target} and y_{predicted}. A small value for y_{predicted} might have been the result of starting with a noisy frame, which corresponds to a small value of y_{target}, and continuing with over-suppression, which leads to an even smaller value for y_{predicted}. When the difference between y_{target} and y_{predicted} is amplified into the difference between y_{target}^{p} and y_{predicted}^{p} as appropriate (using overly small values for p might lead to over-frequent amplification), such speech over-suppression is penalized more. Therefore, the power law terms may especially help ameliorate speech over-suppression for the difficult cases of noisy frames. Such inherent focus on difficult cases also leads to the possibility to have a smaller machine learning model with fewer parameters. The total loss for an audio signal that corresponds to a plurality of frequency bands and a plurality of frames could be computed as the sum or average of the loss values over the plurality of frequency bands and the plurality of frames.

In some embodiments, the perceptual loss function Loss is based on the MSE as follows:

$$diff = {y}_{target}^{p} - {y}_{predicted}^{p} \qquad ( 3 )$$

$$w = {m}^{diff} - diff - 1 \qquad ( 4 )$$

$$Loss = w * {diff}^{2} , \qquad ( 5 )$$

With the MSE, positive diff values and negative diff values are penalized equally, and so negative diff values indicating speech over-suppression are not penalized more than the positive diff values indicating speech under-suppression. With Loss defined by equation (5), significant speech under-suppression corresponding to a predicted mask value much lower than the target mask value is now punished multiple times, through w (a corresponding large weight) and through diff² (a corresponding large error).

### 4.2. Model Execution for Speech Enhancement

In some embodiments, the server 102 is programmed to receive a new audio signal having one or more frames in the time domain. The server 102 then applies the machine learning approach discussed in Section 4.1. to the new audio signal to generate the predicted mask indicating an amount of speech present for each frame and each frequency band in the corresponding T-F representation. The application includes converting the new audio signal to the joint T-F representation that initially covers a plurality of frames and a plurality of frequency bins.

In some embodiments, the server 102 is programmed to further generate an improved audio signal for the new audio signal based on the predicted mask. Given a band mask for y (obtained from applying the machine learning approach discussed in Section 4.1) as a column vector m_band of size q by 1, where y is a column vector of size q by 1 representing band energies for an original noisy frame, q denotes the number of perceptually motivated bands, the conversion to the bin masks can be performed by computing m_bin=W_transpose*m_band, where m_bin is a column vector of size p by 1, p denotes the number of bins, and W_transpose of size of p by q is the transpose of W, a banding matrix of size q by p.

In some embodiments, the server 102 is programmed to apply the bin mask to the original frequency bin magnitudes in the joint T-F representation to effect the masking or reduction of noise and obtain an estimated clean spectrum. The server 102 can further convert the estimated clean spectral spectrum back to a waveform as an enhanced waveform (over the noise waveform), which could be communicated via an output device, using any method known to someone skilled in the art, such as an inverse CQMF.

### 5. EXAMPLE PROCESSES

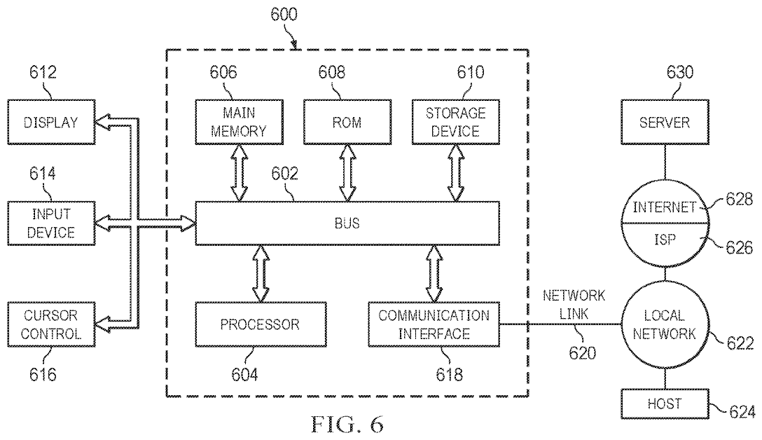

FIG. 5 illustrates an example process performed by an audio management computer system in accordance with some embodiments described herein. FIG. 5 is shown in simplified, schematic format for purposes of illustrating a clear example and other embodiments may include more, fewer, or different elements connected in various manners. FIG. 5 is each intended to disclose an algorithm, plan or outline that can be used to implement one or more computer programs or other software elements which when executed cause performing the functional improvements and technical advances that are described herein. Furthermore, the flow diagrams herein are described at the same level of detail that persons of ordinary skill in the art ordinarily use to communicate with one another about algorithms, plans, or specifications forming a basis of software programs that they plan to code or implement using their accumulated skill and knowledge.

In some embodiments, the server 102 is programmed to receive an input waveform in a time domain and transform the input waveform into raw audio data over a plurality of frequency bins and the plurality of frames. The server 102 is further programmed to convert the raw audio data into the audio data by grouping the plurality of frequency bins into the plurality of frequency bands, where the joint time-frequency representation has an energy value for each time frame and each frequency band.

Therefore, in step 502, the server 102 is programmed to receive audio data as a joint time-frequency representation over a plurality of frames and a plurality of frequency bands.

In some embodiments, the server 102 is programmed to generate a feature vector from the joint time-frequency representation.

In step 504, then, the server 102 is programmed to execute a digital model for detecting speech from the feature vector of the audio data. The digital model comprises a series of masking blocks. Each masking block comprises a first component that generates a first mask for extracting speech and a second component that generates a second mask for extracting residual speech masked by the first mask. Each mask of the first mask and the second mask includes mask values estimating an amount of speech present for each frame of the plurality of frames and each frequency band of the plurality of frequency bands.

In some embodiments, the first component comprises a series of connected CNN blocks with dilation. Each CNN block of the series of connected CNN blocks comprises a CNN layer, a batch normalization layer, and an activation layer. The first component also comprises a CNN layer having a 1×1 filter. In other embodiments, the second component comprises a gated recurrent unit (GRU) block including a GRU layer.

In some embodiments, the first component of a first masking block of the series of masking blocks receives the feature vector as an input, and the second component of the first masking block receives an inverse of a result of applying the first mask to the feature vector.

In some embodiments, each masking block comprises a third component comprising CNN blocks configured to combine the first mask and the second mask into an output mask. Each masking block further comprises a fourth component that applies the output mask to a certain feature vector to generate a specific feature vector. A first masking block of the series of masking blocks receives the feature vector as the certain feature vector. Each subsequent masking block of the series of masking blocks receives the specific feature vector produced by a preceding masking block as an input.

In some embodiments, the digital model further comprises an input CNN block comprising a CNN layer with one lookahead filter, a batch normalization layer, and an activation layer.

In step 506, the server 102 is programmed to transmit information related the first masks produced by the series of masking blocks to a device.

In some embodiments, the digital model further comprises a mask combination block comprising CNN blocks that combines the first masks generated from the series of masking blocks into a final mask. In other embodiments, the server 102 is programmed to perform inverse banding on mask values of the final mask to generate updated mask values for each frequency bin of a plurality of frequency bins and each frame of the plurality of frames. The server 102 is further programmed to apply the updated mask values to the audio data to generate new output data and transform the new output data into an enhanced waveform.

Various aspects of the disclosed embodiments may be appreciated from the following enumerated example embodiments (EEEs):

EEE 1. A computer-implemented method of mitigating audio artifacts, comprising: receiving, by a processor, audio data as a joint time-frequency representation over a plurality of frames and a plurality of frequency bands; executing, by the processor, a digital model for detecting speech from a feature vector of the audio data, the digital model comprising a series of masking blocks, each masking block comprising a first component that generates a first mask for extracting speech and a second component that generates a second mask for extracting residual speech masked by the first mask, and each mask of the first mask and the second mask including mask values estimating an amount of speech present for each frame of the plurality of frames and each frequency band of the plurality of frequency bands; and transmitting information related the first masks produced by the series of masking blocks to a device.

EEE 2. The computer-implemented method of claim 1, the first component comprising a series of connected convolutional neural network (CNN) blocks with dilation.

EEE 3. The computer-implemented method of claim 2, each CNN block of the series of connected CNN blocks comprising a CNN layer, a batch normalization layer, and an activation layer.

EEE 4. The computer-implemented method of any of claims 1-3, the first component comprising a CNN layer having a 1×1 filter.

EEE 5. The computer-implemented method of any of claims 1-4, the second component comprising a gated recurrent unit (GRU) block including a GRU layer.

EEE 6. The computer-implemented method of any of claims 1-5, each masking block comprising a third component comprising CNN blocks configured to combine the first mask and the second mask into an output mask.

EEE 7. The computer-implemented method of claim 6, each masking block further comprising a fourth component that applies the output mask to a certain feature vector to generate a specific feature vector, a first masking block of the series of masking blocks receiving the feature vector as the certain feature vector, and each subsequent masking block of the series of masking blocks receiving the specific feature vector produced by a preceding masking block as an input.

EEE 8. The computer-implemented method of any of claims 1-7, the first component of a first masking block of the series of masking blocks receiving the feature vector as an input, and the second component of the first masking block receiving an inverse of a result of applying the first mask to the feature vector.

EEE 9. The computer-implemented method of any of claims 1-8, the digital model further comprising an input CNN block comprising a CNN layer with one lookahead filter, a batch normalization layer, and an activation layer.

EEE 10. The computer-implemented method of any of claims 1-9, the digital model further comprising a mask combination block comprising CNN blocks that combines the first masks generated from the series of masking blocks into a final mask.

EEE 11. The computer-implemented method of claim 10, further comprising: performing inverse banding on mask values of the final mask to generate updated mask values for each frequency bin of a plurality of frequency bins and each frame of the plurality of frames; applying the updated mask values to the audio data to generate new output data; and transforming the new output data into an enhanced waveform.

EEE 12. The computer-implemented method of any of claims 1-11, further comprising: receiving an input waveform in a time domain; transforming the input waveform into raw audio data over a plurality of frequency bins and the plurality of frames; converting the raw audio data into the audio data by grouping the plurality of frequency bins into the plurality of frequency bands, the joint time-frequency representation having an energy value for each time frame and each frequency band; and generating the feature vector from the joint time-frequency representation.

EEE 13. The computer-implemented method of any of claims 1-12, further comprising training the digital model with a loss function with non-linear penalty that penalizes speech over-suppression more than speech under-suppression.

EEE 14. A system for mitigating over-suppression of speech, comprising: a memory; and one or more processors coupled to the memory and configured to perform: receiving audio data as a joint time-frequency representation over a plurality of frames and a plurality of frequency bands; executing a digital model for detecting speech from a feature vector of the audio data, the digital model comprising a series of masking blocks, each masking block comprising a first component that generates a first mask for extracting speech and a second component that generates a second mask for extracting residual speech masked by the first mask, and each mask of the first mask and the second mask including mask values estimating an amount of speech present for each frame of the plurality of frames and each frequency band of the plurality of frequency bands; and transmitting information related the first masks produced by the series of masking blocks to a device.

EEE 15. A computer-readable, non-transitory storage medium storing computer-executable instructions, which when executed implement a method of mitigating audio artifacts, the method comprising: receiving, by a processor, audio data as a joint time-frequency representation over a plurality of frames and a plurality of frequency bands; executing a digital model for detecting speech from a feature vector of the audio data, the digital model comprising a masking block comprising a first series of CNN blocks that generates a first mask for extracting speech and a GRU block that generates a second mask for extracting residual speech masked by the first mask, each CNN block of the first series of CNN blocks comprising a CNN layer and the GRU block comprises a GRU layer, and each of the first mask and the second mask including mask values estimating an amount of speech present for each frame of the plurality of frames and each frequency band of the plurality of frequency bands; and transmitting information related the first mask and the second mask.

EEE 16. The computer-readable, non-transitory storage medium of claim 15, the masking block further comprising an additional block that derives a specific feature vector from a certain feature vector using the first mask and the second mask, the digital model comprising a series of masking blocks including the masking block, a first masking block of the series of masking blocks receiving the feature vector, and each subsequent masking block of the series of masking blocks receiving the specific feature vector produced by a preceding masking block as an input.

EEE 17. The computer-readable, non-transitory storage medium of claim 16, the digital model further comprising a mask combination block comprising CNN blocks that combine the first masks generated by the series of masking blocks into a final mask.

EEE 18. The computer-readable, non-transitory storage medium of any of claims 15-17, the first series of CNN blocks having increasing dilation rates followed by decreasing dilation rates.

EEE 19. The computer-readable, non-transitory storage medium of any of claims 15-18, the masking block further comprising CNN blocks that combine the first mask and the second mask into an output mask.

EEE 20. The computer-readable, non-transitory storage medium of any of claims 15-19, the digital model further comprising an input CNN block comprising a CNN layer with one lookahead filter, a batch normalization layer, and an activation layer.

### 6. HARDWARE IMPLEMENTATION

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

FIG. 6 is a block diagram that illustrates an example computer system with which an embodiment may be implemented. In the example of FIG. 6, a computer system 600 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 600 includes an input/output (I/O) subsystem 602 which may include a bus and/or other communication mechanism(s) for communicating information and/or instructions between the components of the computer system 600 over electronic signal paths. The I/O subsystem 602 may include an I/O controller, a memory controller and at least one I/O port. The electronic signal paths are represented schematically in the drawings, for example as lines, unidirectional arrows, or bidirectional arrows.

At least one hardware processor 604 is coupled to I/O subsystem 602 for processing information and instructions. Hardware processor 604 may include, for example, a general-purpose microprocessor or microcontroller and/or a special-purpose microprocessor such as an embedded system or a graphics processing unit (GPU) or a digital signal processor or ARM processor. Processor 604 may comprise an integrated arithmetic logic unit (ALU) or may be coupled to a separate ALU.

Computer system 600 includes one or more units of memory 606, such as a main memory, which is coupled to I/O subsystem 602 for electronically digitally storing data and instructions to be executed by processor 604. Memory 606 may include volatile memory such as various forms of random-access memory (RAM) or other dynamic storage device. Memory 606 also may be used for storing temporary variables or other intermediate information during execution of instructions to be executed by processor 604. Such instructions, when stored in non-transitory computer-readable storage media accessible to processor 604, can render computer system 600 into a special-purpose machine that is customized to perform the operations specified in the instructions.

Computer system 600 further includes non-volatile memory such as read only memory (ROM) 608 or other static storage device coupled to I/O subsystem 602 for storing information and instructions for processor 604. The ROM 608 may include various forms of programmable ROM (PROM) such as erasable PROM (EPROM) or electrically erasable PROM (EEPROM). A unit of persistent storage 610 may include various forms of non-volatile RAM (NVRAM), such as FLASH memory, or solid-state storage, magnetic disk or optical disk such as CD-ROM or DVD-ROM, and may be coupled to I/O subsystem 602 for storing information and instructions. Storage 610 is an example of a non-transitory computer-readable medium that may be used to store instructions and data which when executed by the processor 604 cause performing computer-implemented methods to execute the techniques herein.

The instructions in memory 606, ROM 608 or storage 610 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file processing instructions to interpret and render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or NoSQL, an object store, a graph database, a flat file system or other data storage.

Computer system 600 may be coupled via I/O subsystem 602 to at least one output device 612. In one embodiment, output device 612 is a digital computer display. Examples of a display that may be used in various embodiments include a touch screen display or a light-emitting diode (LED) display or a liquid crystal display (LCD) or an e-paper display. Computer system 600 may include other type(s) of output devices 612, alternatively or in addition to a display device. Examples of other output devices 612 include printers, ticket printers, plotters, projectors, sound cards or video cards, speakers, buzzers or piezoelectric devices or other audible devices, lamps or LED or LCD indicators, haptic devices, actuators or servos.

At least one input device 614 is coupled to I/O subsystem 602 for communicating signals, data, command selections or gestures to processor 604. Examples of input devices 614 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 616, which may perform cursor control or other automated control functions such as navigation in a graphical interface on a display screen, alternatively or in addition to input functions. Control device 616 may be a touchpad, a mouse, a trackball, or cursor direction keys for communicating direction information and command selections to processor 604 and for controlling cursor movement on the output device 612. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 614 may include a combination of multiple different input devices, such as a video camera and a depth sensor.

In another embodiment, computer system 600 may comprise an internet of things (IoT) device in which one or more of the output device 612, input device 614, and control device 616 are omitted. Or, in such an embodiment, the input device 614 may comprise one or more cameras, motion detectors, thermometers, microphones, seismic detectors, other sensors or detectors, measurement devices or encoders and the output device 612 may comprise a special-purpose display such as a single-line LED or LCD display, one or more indicators, a display panel, a meter, a valve, a solenoid, an actuator or a servo.

When computer system 600 is a mobile computing device, input device 614 may comprise a global positioning system (GPS) receiver coupled to a GPS module that is capable of triangulating to a plurality of GPS satellites, determining and generating geo-location or position data such as latitude-longitude values for a geophysical location of the computer system 600. Output device 612 may include hardware, software, firmware and interfaces for generating position reporting packets, notifications, pulse or heartbeat signals, or other recurring data transmissions that specify a position of the computer system 600, alone or in combination with other application-specific data, directed toward host computer 624 or server 630.

Computer system 600 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 600 in response to processor 604 executing at least one sequence of at least one instruction contained in main memory 606. Such instructions may be read into main memory 606 from another storage medium, such as storage 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 610. Volatile media includes dynamic memory, such as memory 606. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 602. Transmission media can also take the form of acoustic or light waves, such as those generated during radio-wave and infra-red data communications.

Various forms of media may be involved in carrying at least one sequence of at least one instruction to processor 604 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 600 can receive the data on the communication link and convert the data to be read by computer system 600. For instance, a receiver such as a radio frequency antenna or an infrared detector can receive the data carried in a wireless or optical signal and appropriate circuitry can provide the data to I/O subsystem 602 such as place the data on a bus. I/O subsystem 602 carries the data to memory 606, from which processor 604 retrieves and executes the instructions. The instructions received by memory 606 may optionally be stored on storage 610 either before or after execution by processor 604.

Computer system 600 also includes a communication interface 618 coupled to I/O subsystem 602. Communication interface 618 provides a two-way data communication coupling to network link(s) 620 that are directly or indirectly connected to at least one communication networks, such as a network 622 or a public or private cloud on the Internet. For example, communication interface 618 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 622 broadly represents a LAN, WAN, campus network, internetwork or any combination thereof. Communication interface 618 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 618 sends and receives electrical, electromagnetic or optical signals over signal paths that carry digital data streams representing various types of information.

Network link 620 typically provides electrical, electromagnetic, or optical data communication directly or through at least one network to other data devices, using, for example, satellite, cellular, Wi-Fi, or BLUETOOTH technology. For example, network link 620 may provide a connection through a network 622 to a host computer 624.

Furthermore, network link 620 may provide a connection through network 622 or to other computing devices via internetworking devices and/or computers that are operated by an Internet Service Provider (ISP) 626. ISP 626 provides data communication services through a world-wide packet data communication network represented as internet 628. A server computer 630 may be coupled to internet 628. Server 630 broadly represents any computer, data center, virtual machine or virtual computing instance with or without a hypervisor, or computer executing a containerized program system such as DOCKER or KUBERNETES. Server 630 may represent an electronic digital service that is implemented using more than one computer or instance and that is accessed and used by transmitting web services requests, uniform resource locator (URL) strings with parameters in HTTP payloads, application programming interface (API) calls, app services calls, or other service calls. Computer system 600 and server 630 may form elements of a distributed computing system that includes other computers, a processing cluster, server farm or other organization of computers that cooperate to perform tasks or execute applications or services. Server 630 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to interpret or render files coded using HTML, XML, JPEG, MPEG or PNG; user interface instructions to render or interpret commands for a GUI, command-line interface or text user interface; application software such as an office suite, internet access applications, design and manufacturing applications, graphics applications, audio applications, software engineering applications, educational applications, games or miscellaneous applications. Server 630 may comprise a web application server that hosts a presentation layer, application layer and data storage layer such as a relational database system using structured query language (SQL) or NoSQL, an object store, a graph database, a flat file system or other data storage.

Computer system 600 can send messages and receive data and instructions, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage 610, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 604. While each processor 604 or core of the processor executes a single task at a time, computer system 600 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### 7. EXTENSIONS AND ALTERNATIVES

In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1. A computer-implemented method of mitigating audio artifacts, comprising:
receiving, by a processor, audio data as a joint time-frequency representation over a plurality of frames and a plurality of frequency bands;
executing, by the processor, a digital model for detecting speech from a feature vector of the audio data,
the digital model comprising a series of masking blocks,
each masking block comprising a first component that generates a first mask for extracting speech and a second component that generates a second mask for extracting residual speech masked by the first mask, and
each mask of the first mask and the second mask including mask values estimating an amount of speech present for each frame of the plurality of frames and each frequency band of the plurality of frequency bands; and
transmitting information related the first masks produced by the series of masking blocks to a device.

2. The computer-implemented method of claim 1, the first component comprising a series of connected convolutional neural network (CNN) blocks with dilation.

3. The computer-implemented method of claim 2, each CNN block of the series of connected CNN blocks comprising a CNN layer, a batch normalization layer, and an activation layer.

4. The computer-implemented method of claim 1, the first component comprising a CNN layer having a 1×1 filter.

5. The computer-implemented method of claim 1, the second component comprising a gated recurrent unit (GRU) block including a GRU layer.

6. The computer-implemented method of claim 1, each masking block comprising a third component comprising CNN blocks configured to combine the first mask and the second mask into an output mask.

7. The computer-implemented method of claim 6,
each masking block further comprising a fourth component that applies the output mask to a certain feature vector to generate a specific feature vector,
a first masking block of the series of masking blocks receiving the feature vector as the certain feature vector, and
each subsequent masking block of the series of masking blocks receiving the specific feature vector produced by a preceding masking block as an input.

8. The computer-implemented method of claim 1,
the first component of a first masking block of the series of masking blocks receiving the feature vector as an input, and
the second component of the first masking block receiving an inverse of a result of applying the first mask to the feature vector.

9. The computer-implemented method of claim 1, the digital model further comprising an input CNN block comprising a CNN layer with one lookahead filter, a batch normalization layer, and an activation layer.

10. The computer-implemented method of claim 1, the digital model further comprising a mask combination block comprising CNN blocks that combines the first masks generated from the series of masking blocks into a final mask.

11. The computer-implemented method of claim 10, further comprising:
performing inverse banding on mask values of the final mask to generate updated mask values for each frequency bin of a plurality of frequency bins and each frame of the plurality of frames;
applying the updated mask values to the audio data to generate new output data; and
transforming the new output data into an enhanced waveform.

12. The computer-implemented method of claim 1, further comprising:
receiving an input waveform in a time domain;
transforming the input waveform into raw audio data over a plurality of frequency bins and the plurality of frames;
converting the raw audio data into the audio data by grouping the plurality of frequency bins into the plurality of frequency bands,
the joint time-frequency representation having an energy value for each time frame and each frequency band; and
generating the feature vector from the joint time-frequency representation.

13. The computer-implemented method of claim 1, further comprising training the digital model with a loss function with non-linear penalty that penalizes speech over-suppression more than speech under-suppression.

14. A system for mitigating over-suppression of speech, comprising:
a memory; and
one or more processors coupled to the memory and configured to perform:
receiving audio data as a joint time-frequency representation over a plurality of frames and a plurality of frequency bands;
executing a digital model for detecting speech from a feature vector of the audio data,
the digital model comprising a series of masking blocks,
each masking block comprising a first component that generates a first mask for extracting speech and a second component that generates a second mask for extracting residual speech masked by the first mask, and
each mask of the first mask and the second mask including mask values estimating an amount of speech present for each frame of the plurality of frames and each frequency band of the plurality of frequency bands; and
transmitting information related the first masks produced by the series of masking blocks to a device.

15. A computer-readable, non-transitory storage medium storing computer-executable instructions, which when executed implement a method of mitigating audio artifacts, the method comprising:
receiving, by a processor, audio data as a joint time-frequency representation over a plurality of frames and a plurality of frequency bands;
executing a digital model for detecting speech from a feature vector of the audio data,
the digital model comprising a masking block comprising a first series of CNN blocks that generates a first mask for extracting speech and a GRU block that generates a second mask for extracting residual speech masked by the first mask,
each CNN block of the first series of CNN blocks comprising a CNN layer and the GRU block comprises a GRU layer, and
each of the first mask and the second mask including mask values estimating an amount of speech present for each frame of the plurality of frames and each frequency band of the plurality of frequency bands; and
transmitting information related the first mask and the second mask.

16. The computer-readable, non-transitory storage medium of claim 15,
the masking block further comprising an additional block that derives a specific feature vector from a certain feature vector using the first mask and the second mask,
the digital model comprising a series of masking blocks including the masking block,
a first masking block of the series of masking blocks receiving the feature vector, and
each subsequent masking block of the series of masking blocks receiving the specific feature vector produced by a preceding masking block as an input.

17. The computer-readable, non-transitory storage medium of claim 16, the digital model further comprising a mask combination block comprising CNN blocks that combine the first masks generated by the series of masking blocks into a final mask.

18. The computer-readable, non-transitory storage medium of claim 15, the first series of CNN blocks having increasing dilation rates followed by decreasing dilation rates.

19. The computer-readable, non-transitory storage medium of claim 15, the masking block further comprising CNN blocks that combine the first mask and the second mask into an output mask.

20. The computer-readable, non-transitory storage medium of claim 15, the digital model further comprising an input CNN block comprising a CNN layer with one lookahead filter, a batch normalization layer, and an activation layer.
